(19) United States
(12) Patent Application Publication
(10) Pub. No.: US 2007/0203281 A1
(43) Pub. Date: Aug. 30, 2007

(54) Thermally-stable fluorinated composition

(76) Inventors: Jerome Alric, L'isle d'abeau (FR); Olivier Pinto, Lyon (FR); Lawrence Letch, Lititz, PA (US); Gilberto Lunardi, Lititz, PA (US)

Correspondence Address: SOFER & HAROUN LLP., 317 MADISON AVENUE, SUITE 910, NEW YORK, NY, 10017, US

(21) Appl. No.: 11/594,000

(22) Filed: Nov. 7, 2006

(30) Foreign Application Priority Data
Jan. 12, 2006 (FR) 06 50112

(51) Int. Cl. C08K 3/22; C08K 3/18

(52) U.S. Cl. 524/430; 524/497; 524/544

(57) ABSTRACT

The invention provides a thermally-stable extrudable composition comprising fluropolymer and titanium dioxide, and further comprising an inorganic filler suitable for neutralizing the acid that forms during the step of extruding the composition, the filler having particles with a mean size of less than 100 nm, and preferably less than 60 nm.

### RELATED APPLICATION

This application is related to and claims the benefit of priority from French Patent Application No. 06 50112, filed on Jan. 12, 2006, the entirety of which is incorporated herein by reference.

### FIELD OF THE INVENTION

The present invention relates to a thermally-stable extrudable composition for use in insulating electrical cables, and it also relates to an electrical conductor coated in such an extruded composition.

The invention applies typically to insulating copper wires in the field of local area network (LAN) cables by using insulation based on a fluropolymer, and more generally the invention relates to data transmission cables.

In an embodiment, the composition is used for insulating a portion of cables in categories 5, 5e, 6, and 6e, and in particular the white portion of such cables. These cables are formed by assembling together four twisted pairs, in which each twisted pair comprises a copper wire insulated by insulation of white color associated with a copper wire insulated with colored insulation.

### BACKGROUND OF THE INVENTION

Patent document WO 01/80253 proposes an insulating mixture for an electrical cable, the mixture being suitable for being extruded at high speed and being made up of a pigmented fluropolymer. The pigment used is titanium oxide covered in at least one layer of oxides of silicon and of aluminum. Nevertheless, that composition does not enable acceptable thermal stability to be obtained during the extrusion step. Thus, the thermal degradation caused by that step leads to a flawed surface appearance and to an internal structure of the insulation that is not uniform. The sheath formed in that way presents insulation defects with consequent risks of electrical malfunction and zones that become blackened or discolored.

### OBJECT AND SUMMARY OF THE INVENTION

The invention seeks to solve the problems of the prior art by proposing a fluorinated composition presenting improved thermal stability, in particular during the thermal transformation steps applied to the composition, thus enabling an insulating material to be obtained that is free from any insulation defects.

To this end, and in a first aspect, the invention provides a thermally-stable extrudable composition comprising a fluropolymer, titanium dioxide, and also an inorganic filler suitable for neutralizing the acid formed during the step of extruding the composition, the filler having particles with a mean size of less than 100 nanometers (nm), and preferably less than 60 nm.

By means of the invention, the thermal degradation of the polymer during the extrusion process is limited in significant manner.

In an advantageous embodiment, the inorganic filler is selected from: zinc oxide, magnesium oxide, and calcium oxide.

In particular, the preferred filler is zinc oxide. Zinc oxide is the most suitable trap for neutralizing hydrofluoric acid, in particular during the reactions that take place at high temperature as occurs during the step of extruding fluropolymers.

In an embodiment, the concentration of the filler is less than 5% by weight of the composition, and preferably less than 2%.

According to another characteristic, the concentration of the titanium dioxide is less than 30% by weight of the composition, and preferably lies in the range 5% to 15%.

Said concentrations of filler and of titanium dioxide thus limit any modifications to the Theological properties of the fluorinated composition.

Furthermore, the fluropolymer is a fluorinated ethylene propylene (FEP) copolymer.

Preferably, the FEP is selected from tetrafluoroethylene and hexafluoroisopropene copolymer or from tetrafluoroethylene and hexafluoroisopropene and perfluoroalkyl vinyl ether copolymer. This is the type of copolymer that is most commonly used in insulating the twisted pairs of LAN cables.

In a second aspect, the invention provides an electrical conductor coated in at least one insulating layer, said layer being obtained from the composition of the invention.

The advantage of such insulation is that it provides the entire electrical conductor with uniform protection, thus making it possible to avoid, for example, electric breakdowns while presenting an appearance that is uniform and not discolored.

### BRIEF DESCRIPTION OF THE DRAWING

The invention can be better understood from the following description given with reference to the accompanying drawing showing various embodiments.

FIG. 1 compares the thermal stability of extruded fluorinated compositions of the invention and of the prior art.

### MORE DETAILED DESCRIPTION

During extrusion steps, fluropolymers are subjected to various stresses, and in particular to shear stresses and to thermal stresses, with a temperature profile varying in the range 250° C. to 400° C.

An inevitable consequence of those two types of stress is degradation to the ends of carbonyl chains, such as the —COF or —COOH groups, and chaining defects between macromolecules, for example coming from thermally unstable hexafluoroisopropene (HFP) diads.

These sites thus constitute precursors for the thermal degradation process of fluropolymers.

The thermal degradation leads to hydrofluoric acid being formed, thereby feeding the process whereby the extruded fluorinated composition is degraded.

Titanium dioxide is used to whiten some of the sheaths used in cables for data transmission, and in particular LAN cables.

Titanium dioxide is the white pigment in most widespread use for coloring plastics materials because its coloring power is greater than that of other white pigments such as zinc sulfide or lithopone white.

There are two types of titanium dioxide: rutile lattice and anatase lattice. When coloring plastics materials, the grades commonly used are of the rutile type, because of their better durability.

It is known that titanium dioxide, in fluorinated compositions, reacts with the hydrofluoric acid released during the extrusion stage so as to form titanium tetrafluoride.

In a particular example, when titanium dioxide is covered in alumina in order to improve its dispersion in the plastics material, another metallic halide forms in the presence of hydrofluoric acid, such as aluminum trifluoride.

Under such circumstances, the metallic halides accelerate chain-cleaving reactions, thereby accelerating the process whereby the extruded fluorinated composition is thermally degraded.

The resulting sheath suffers irreversible degradation of its chemical structure, leading to the appearance of microbubbles, to the formation of aggregates, and in the end to blackening of the sheath that was initially white in color.

The invention thus seeks to limit the process whereby extrudable compositions based on fluropolymer and including titanium dioxide suffer thermal degradation.

To do this, the invention proposes adding into said composition an inorganic filler that is suitable for neutralizing the acid formed during the step of extruding the composition, the filler having particles with a mean size smaller than 100 nm, and preferably smaller than 60 nm.

This mean particle size makes it possible to obtain action that is effective on the process of stabilizing pigmented fluorinated compositions. The smaller the mean size of the particles, the greater then specific surface area of the filler since specific surface area is inversely proportional to the mean size of the particles. It is therefore necessary to have the greatest possible area of filler in contact with said composition.

Said filler is a solid material that does not interact chemically with the polymer matrix and that serves to neutralize the hydrofluoric acid progressively as it forms.

The formation of metallic halides is thus substantially avoided, thereby considerably slowing down the rate at which the extruded polymer resin degrades.

The resulting insulating material is uniform in its chemical structure and presents neither insulation defects nor aggregates.

As a result, the white color of the insulation is long-lasting and no trace of blackening is visible at its surface.

In a particular embodiment, the acid-trapping inorganic filler is zinc oxide.

Among the various possible “acid-trapping” fillers, such as metallic stearates and grades of hydrotalcite and of hydrocalumite, zinc oxide is the filler that is the most thermally stable.

Zinc oxide is thus particularly suitable for stabilizing systems that are subjected to high transformation temperatures, in particular when extruding fluropolymers.

In a particular example, the composition includes nanometric zinc oxide with particles having mean size lying in the range 35 nm to 55 nm.

In another embodiment of the invention, the filler is selected from dehydrated alkaline fillers such as magnesium oxide or calcium oxide.

In a particular example, the composition comprises nanometric magnesium oxide or nanometric calcium oxide with particles having a mean size respectively of about 30 nm or 40 nm.

The concentration of the filler is less than 5% by weight of the composition, and preferably less than 2%.

The advantage of using a filler presenting a large specific area is that it enables the composition to be stabilized with said filler at a low concentration relative to the concentration of titanium dioxide, thereby not changing the rheological properties of the pigmented fluorinated composition.

According to another characteristic of the invention, the concentration of titanium dioxide is less than 30% by weight of the composition, and preferably lies in the range 5% to 15%.

The concentration of pigment in the extruded fluorinated composition and the dilution of this composition in an unfilled fluorinated resin during the stage of insulating an electrical conductor, in particular a copper wire, are the two parameters that govern the final color of the insulation.

If the concentration of the pigment is greater than 30%, then problems of rheology appear: the dispersion of the pigment within the fluorinated composition is of a quality that is spoilt by the formation of pigment aggregates and agglomerates. This results in the insulation presenting non-uniform final coloring.

If the concentration of the pigment is less than 5%, then a much larger proportion of the extruded fluorinated composition needs to be used in addition to the unfilled fluorinated resin.

The fluropolymer may be selected in particular from copolymers of tetrafluoroethylene such as fluorinated ethylene propylene copolymer (FEP), ethylene tetrafluoroethylene (ETFE) copolymer, ethylene fluorinated ethylene propylene terpolymer (EFEP from Daikin or HTE from Dyneon), tetrafluoroethylene and perfluoromethyl vinyl ether copolymer (MFA), and tetrafluoroethylene and perfluoropropyl vinyl ether copolymer (PFA), and also homopolymers, copolymers, and terpolymers containing polyvinylidene fluoride (PVDF, THV).

In a particular embodiment of the invention, the composition comprises a copolymer of fluorinated ethylene propylene (FEP), in particular the copolymer of tetrafluoroethylene (TFE) and hexafluoroisopropene (HFP).

It is also possible to use modified FEP copolymers. While synthesizing modified FEPs, modification is performed by adding a third monomer in a minority quantity, which monomer may be perfluoroalkyl vinyl ether (PAVE) of the perfluoropropyl vinyl ether (PPVE) or perfluoroethyl vinyl ether (PEVE) type.

These monomers are used for synthesizing FEPs not only in order to provide better control over the molar distribution of the fluoropolymer, but their presence also makes it possible to improve significantly the mechanical properties of compositions of this type, and in particular their ability to withstand fatigue under stress. Nevertheless, perfluoroalkyl vinyl ether motifs are much more sensitive to metallic halides than are TFE or HFP motifs, thus making the macromolecular chain more vulnerable.

The main but non-limiting application of the invention lies in the field of data transmission cables. The invention relates in particular to electrical conductors coated in at least one insulating layer obtained from the composition of the invention.

In order to show the advantages obtained with compositions of the invention, an experimental protocol has been devised for placing the fluorinated composition in conditions of temperature and shear close to those encountered within the body of a single-screw extruder.

The stability of the material can be evaluated in two ways. The first consists in following variation in the newtonian viscosity of the fluorinated composition at various stages of thermal degradation. The composition that presents the smallest drop in viscosity as a function of the duration of treatment is the most thermally stable. The second analysis consists in progressively comparing variation in the white color of the composition towards a discolored gray, which is a consequence of its thermal degradation.

Samples were prepared by mixing the FEP resin, the pigments, and the fillers using a Berstorff Bi-Vis extruder having two co-rotating screws.

The inorganic filler used was nanometric zinc oxide with particles having a mean size lying in the range 35 nm to 55 nm, and having a specific surface area of about 20 square meters per gram (m²/g) to 30 m²/g.

Table 1 gives the compositions of the samples of the various mixtures studied in the context of the invention.

TABLE 1

| | | TiO₂ | Inorganic filler | | |
|---|---|---|---|---|---|
| Reference | Fluorinated | % by | % by | | Mean size of |
| sample | polymer | weight | weight | | particles μm |
| A | TFE/HFP¹ | — | — | | — |
| | copolymer | | | | |
| B | TFE/HFP/PAVE² | — | — | | — |
| | copolymer | | | | |
| C | TFE/HFP/PAVE² | 15% | — | | — |
| | copolymer | | | | |
| D | TFE/HFP/PAVE² | 14.8% | 0.2% | ZnO | 0.035-0.055 |
| | copolymer | | | | |
| E | TFE/HFP/PAVE² | 14% | 1% | ZnO | 0.035-0.055 |
| | copolymer | | | | |

¹MFI (melt flow index) = 22.
²MFI = 26.

The extruded fluorinated composition was then cooled in a bath of water, and then dried and granulated.

The resulting granules were placed in the tube of a capillary rheometer at 400° C. They were extruded through a die (L/D=30) under shear of 1500 per second (s⁻¹) after 60 seconds (s), and subsequently reduced to 50 s⁻¹ after a period of 150 s. A viscosity measurement was recorded once every 30 s over the interval 180 s to 900 s.

For each sample under analysis, variation in the logarithm of the viscosity of the samples A, B, C, D, and E as a function of the duration of the aging of said samples was used for evaluating their thermal stabilities.

Thermal stability was determined by determining the slopes of the curves as obtained in that way.

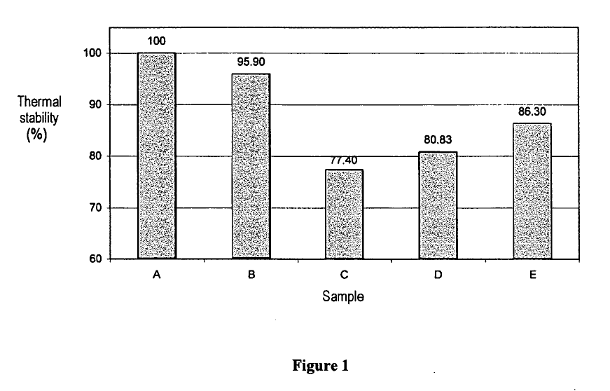

By giving a coefficient equal to 100 to the sample that degraded the most slowly at 400° C. (sample A), or in other words the sample having the highest thermal stability, it is possible to show the relative thermal stabilities of the various samples compared with reference sample A, as plotted in FIG. 1.

### EXAMPLE 1

Sample A was aged using the above-described procedure and presented the greatest thermal stability amongst the samples tested in this study.

### EXAMPLE 2

Sample B was aged using the above-described procedure. Its thermal stability was 4.1% less than that of standard sample A.

### EXAMPLE 3

Sample C was prepared using the above-described procedure while mixing 15% by weight of TiO₂ with the TFE/HFP/PAVE copolymer.

Analysis of the sample using a capillary rheometer showed that its thermal stability dropped by 22.6% compared with standard sample A.

### EXAMPLE 4

Sample D was prepared using the above-described procedure, while mixing 14.8% by weight of TiO₂ and 0.2% by weight of nanometric ZnO with the TFE/HFP/PAVE copolymer, the mean size of the particles lying in the range 0.035 μm to 0.055 μm.

Analysis of the sample in a capillary rheometer showed that its thermal stability was 19.1% lower than that of standard sample A.

### EXAMPLE 5

Sample E was prepared using the above-described procedure with 14% by weight of TiO₂ and 1% by weight of nanometric ZnO being mixed with the TFE/HFP/PAVE copolymer, the mean size of the particles of ZnO lying in the range 0.035 μm to 0.055 μm.

Analysis of the sample in a capillary rheometer showed that its thermal stability was 13.7% lower than that of standard sample A.

Thus, in the light of the results obtained, adding zinc oxide to a fluorinated composition containing titanium dioxide makes it possible to obtain an extruded mixture that presents better thermal stability.

As plotted in FIG. 1, it can clearly be seen that the presence of zinc oxide in samples D and E limits the thermal degradation of the extruded fluropolymer in comparison with the composition containing only TFE/HFP/PAVE copolymer and titanium dioxide (sample C).

The presence of 0.2% of nanometric ZnO (sample D) or of 1% of nanometric ZnO (sample E) serves to improve the thermal stability of the mixture respectively by 4.2% and by 10.3% relative to sample C.

A second way of evaluating the thermal stability of extruded fluorinated compositions that is simple and effective, but not shown, is to observe how the discoloration of the material varies, in particular how it blackens, as a function of time during thermal aging at 400° C.

Sample C was seen to begin to blacken after 5 minutes in the tube of the capillary rheometer.

In comparison, samples D and E, when subjected to the same type of thermal aging, began to be discolored only after 10 minutes in the tube of the capillary rheometer.

The invention is not limited to the above embodiments.

It is also possible to use other fillers such as synthetic hydrocalcites or hydrocalumites.

Finally, the end values of the ranges given should not be considered strictly and can vary within the usual tolerances well known to the person skilled in the art.

What is claimed is:

1. A thermally-stable extrudable composition comprising:
a extruded polymer; and
titanium dioxide;
the composition further including an inorganic filler, suitable for neutralizing the acid formed during the step of extruding the composition, the filler having particles with a mean size of less than 100 nm, and preferably less than 60 nm.

2. A composition according to claim 1, wherein the filler is selected from the group consisting of zinc oxide, magnesium oxide, and calcium oxide.

3. A composition according to claim 1, wherein the concentration of the titanium dioxide is less than 30% by weight of the composition.

4. A composition according to claim 1, wherein the concentration of the filler is less than 5% by weight of the composition.

5. A composition according to claim 1, wherein the fluropolymer is a copolymer of fluorinated ethylene propylene (FEP).

6. A composition according to claim 5, wherein the FEP is selected from the copolymer of tetrafluoroethylene and hexafluoroisopropene and the copolymer of tetrafluoroethylene and hexafluoroisopropene and perfluoroalkyl vinyl ether.

7. An electrical conductor coated in at least one insulating layer, wherein said layer is obtained from the composition according to claim 1.

8. A composition according to claim 1, wherein the concentration of the titanium dioxide is in the range of 5% to 15%.

9. A composition according to claim 1, wherein the concentration of the filler is less than 2% by weight of the composition.
